(19) United States
(12) Patent Application Publication
(10) Pub. No.: US 2025/0038809 A1
(43) Pub. Date: Jan. 30, 2025

(54) METHOD AND APPARATUS FOR MANAGING CHANNEL STATUS INFORMATION IN A WIRELESS COMMUNICATION SYSTEM

(71) Applicant: Samsung Electronics Co., Ltd., Gyeonggi-do (KR)

(72) Inventors: Karthik MURALIDHAR, Bangalore (IN); Md. Saifur RAHMAN, Mountain View, CA (US); Dattaraj Dileep Raut MULGAONKAR, Bangalore (IN); Diwakar SHARMA, Bangalore (IN); Eko ONGGOSANUSI, Mountain View, CA (US)

(21) Appl. No.: 18/716,792

(22) PCT Filed: Feb. 15, 2023
(86) PCT No.: PCT/KR2023/002222

§ 371 Date: Jun. 5, 2024

(30) Foreign Application Priority Data
Feb. 15, 2022 (IN) 202241007986
Feb. 10, 2023 (IN) 202241007986

(51) Int. Cl. H04B 7/06; H04W 24/10; H04W 72/23

(52) U.S. Cl. CPC H04B 7/0626; H04W 24/10; H04W 72/23

(57) ABSTRACT

According to various embodiments, a method performed by a user equipment (UE) in a wireless communication system, comprising: receiving, from a base station, a channel state information (CSI)-reference signal (RS) during an observation window (OW); predicting at least one first type CSI report during the OW; transmitting, to the base station, the at least one predicted first type CSI report during the OW and a second type CSI report at an end of the OW based on the received CSI-RS. The linear prediction based method is used for CSI-feedback in the wireless communication network, in situations where high/medium velocity feedback (i.e., Doppler) is present. The method can be used to enable a CSI-Type 2 codebook feedback feature during a mobility scenario.

### TECHNICAL FIELD

Embodiments disclosed herein relate to wireless communication networks, and more particularly to methods and the wireless communication networks for managing Channel Status Information (CSI) feedback in the wireless communication networks, when Doppler is present.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In a wireless communication network, there is no efficient mechanism for managing CSI feedback in the wireless communication network, when high/medium velocity feedback (i.e., Doppler) is present. The reference “RP-213598-New WID: Multiple Input Multiple Output (MIMO) Evolution for Downlink and Uplink (3rd Generation Partnership Project (3GPP) document)” says for Release-18 work item Sec 4.1:
1. “Study, and if justified, specify CSI reporting enhancement for high/medium User Equipment (UE) velocities by exploiting time-domain correlation/Doppler-domain information to assist downlink (DL) precoding, targeting Frequency Range 1 (FR1) as follows:
a) Rel-16/17 Type-II codebook refinement, without modification to a spatial and frequency domain basis, and
b) UE reporting of time-domain channel properties measured via CSI-RS for tracking.”

In the reference, RP-213599-New SI: Study on Artificial Intelligence (AI)/Machine Learning (ML) for NR Air Interface (3GPP document) says for Release-18 study item Sec 4.1

a) “CSI feedback enhancement, e.g., overhead reduction, improved accuracy, prediction [in radio access network (RAN)]”.

### DISCLOSURE OF INVENTION

### Solution to Problem

The principal object of the embodiments herein is to disclose methods and a wireless network for managing CSI in the wireless network.

Another object of the embodiments herein is to disclose a linear prediction based method for CSI-feedback in the wireless communication network, in situations where high/medium velocity feedback (i.e., Doppler) is present. The method can be used to enable a CSI-Type 2 codebook feedback feature during a mobility scenario.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1A illustrates an example CSI-RS-{OW} scenario with a different type of CSI reports, according to embodiments as disclosed herein;

FIG. 1B illustrates an example CSI-RS-{OW, PW} scenario with a different type of CSI reports, according to embodiments as disclosed herein;

FIG. 2 illustrates a possible way to trigger a scenario CSI-RS-{OW} in a wireless network, according to embodiments as disclosed herein;

FIG. 3 illustrates another possible way to trigger the scenario CSI-RS-{OW} in the wireless network, according to embodiments as disclosed herein;

FIG. 4 illustrates a possible way to trigger the scenario CSI-RS-{OW, PW} in the wireless network, according to embodiments as disclosed herein;

FIG. 5 illustrates a 2D-prediction of a cth subband corresponding to a bth beam for elements of W2, according to embodiments as disclosed herein;

FIG. 6 illustrates a 2D-prediction of a cth FD component corresponding to the bth beam for elements of \tilde{W}₂, according to embodiments as disclosed herein;

FIG. 7 illustrates various hardware components of a UE, according to the embodiments as disclosed herein;

FIG. 8 illustrates various hardware components of a base station (BS), according to the embodiments as disclosed herein;

FIGS. 9 and 10 illustrate flow charts illustrating a method, implemented by the UE, for managing the CSI in a wireless network, according to the embodiments as disclosed herein;

FIGS. 11 and 12 illustrate flow chart illustrating a method, implemented by the base station, for managing the CSI in the wireless network,

FIG. 13 illustrates a block diagram illustrating a structure of a user equipment (UE) according to an embodiment of the disclosure; and

FIG. 14 illustrates a block diagram illustrating a structure of a base station (BS) according to an embodiment of the disclosure, according to the embodiments as disclosed herein.

### BEST MODE FOR CARRYING OUT THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for managing CSI in a wireless network. The method includes receiving, by a UE, a CSI-RS from a base station during an observation window (OW) and optionally during a prediction window (PW). Further, the method includes predicting, by the UE, a first type CSI report during the OW. Further, the method includes sending, by the UE, at least one of the predicted first type CSI report to the base station during the OW and a second type CSI report to the base station at an end of the OW based on the received CSI-RS. the method also includes sending a third type of CSI report during PW if CSI-RS is present in PW.

The proposed method provides a linear prediction based solution for CSI-feedback in the wireless communication networks, in situations where high/medium velocity feedback (i.e., Doppler) is present. The method can be used to enable a CSI-Type 2 codebook feedback feature during a mobility scenario. The proposed method enables a CSI feedback in presence of Doppler in a reduced feedback fashion. To enable this, the proposed method dwells on the messages and configuration between a base station (e.g., gNB) and the UE that makes the reduced CSI report feedback in the Doppler possible.

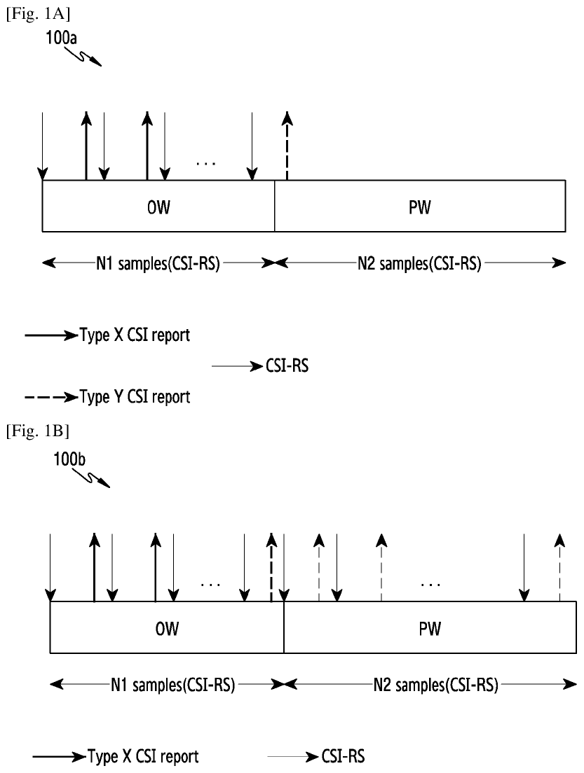

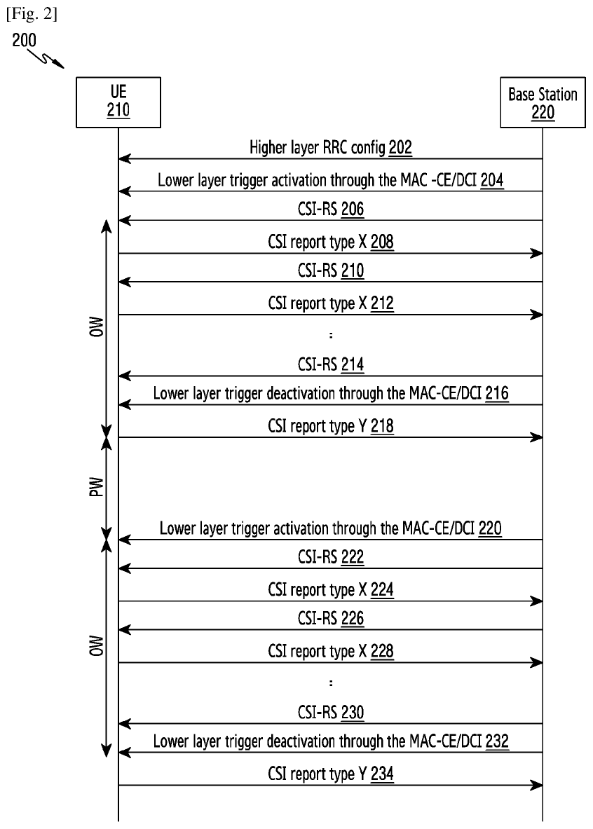

Referring now to the drawings, and more particularly to FIGS. 1 through 12, where similar reference characters denote corresponding features consistently throughout the figures, there are shown at least one embodiment.

Accordingly, the embodiments herein provide methods for managing Channel Status Information (CSI) in a wireless network. The method includes receiving, by a UE, a CSI-RS from a base station during an OW. Further, the method includes predicting/computing, by the UE, a first type CSI report during the OW. Further, the method includes sending, by the UE, at least one of the predicted first type CSI report to the base station during the OW and a second type CSI report to the base station at an end of the OW based on the received CSI-RS.

In an embodiment, the second type CSI report includes at least one predictor coefficient.

In an embodiment, a set of semi-persistent scheduling covers many OWs. In another embodiment, one semi-persistent scheduling covers the one OW. The transmission of CSI-RS is configured by a RRC message and is actually switched ON/OFF by the low layer activation/deactivation messages via the MAC-CE/DCI. Together the operations is called as the semi-persistent scheduling.

In an embodiment, a radio resource control (RRC) message configures at least one of time instants and periodicities of the CSI-RS that is to be transmitted later by one of an activation low layer trigger and deactivation of low layer trigger via a Medium Access Control′ Control Element (MAC-CE) or a Downlink Control Information (DCI) from the base station.

In an embodiment, the UE receives the CSI-RS from the base station upon triggering at least one of a low layer activation message via at least one of the MAC-CE and the DCI by the base station.

In an embodiment, the transmission of the CSI-RS by the base station to the UE is stopped upon triggering at least one of a low layer deactivation message via at least one of the MAC-CE and the DCI from the base station.

In an embodiment, a length of the OW is configured via at least one of the DCI and the MAC-CE during activation.

In an embodiment, the OW and a PW are defined by a Radio resource control (RRC) message, wherein the RRC message comprises a CSI-RS burst pattern.

In an embodiment, at least one linear predictor coefficient associated with the second type CSI report is learned using at least one of a machine learning technique and a signal processing technique.

In an embodiment, a predictor order in one of time and frequency for the second type CSI report is determined by using a time domain order and a frequency domain order, where the time domain order and the frequency domain order depend on coherence time and coherence bandwidth.

In an embodiment, the first type CSI report is different from the second type CSI report, and wherein the CSI feedback is managed in a presence of Doppler.

In an embodiment, the second type CSI report is sent after the OW have precoder matrix values for various time instants in a PW in a compressed format.

Accordingly, the embodiments herein provide methods for managing CSI feedback in a wireless network. The method includes sending, by a base station, a CSI-RS in at least one time instant to a UE during an OW. Further, the method includes receiving, by the base station, a CSI report from the UE during the OW and at an end of the OW based on the CSI-RS.

In an embodiment, the base station receives another CSI report from the UE at the OW. Another CSI report is a first type CSI report and the CSI report is a second type CSI report. Another CSI report is sent prior to the CSI report. The first type CSI report includes at least one predictor coefficient, and the second type CSI report includes at least one predictor coefficient.

Accordingly, the embodiments herein provide methods for managing CSI in a wireless network. The method includes receiving, by a UE, a CSI-RS in at least one time instant from a BS during an OW and a PW. Further, the method includes predicting/computing, by the UE, a first type CSI report for each received CSI-RS. The first type CSI report includes at least one predictor coefficient. Further, the method includes sending, by the UE, the predicted first type CSI report comprising the at least one predictor coefficient to the base station during the OW. Further, the method includes sending, by the UE, a second type CSI report to the base station at the end of the OW, wherein the second type CSI report comprises at least one predictor coefficient, which can be used to predict CSI at various time instants in the PW. Further, the report is sent in a compressed format. In another embodiment, CSI-RS is received in at least one time instant in PW, and for each CSI-RS in PW, a third type CSI report is sent to BS.

Accordingly, the embodiments herein provide methods for managing CSI feedback in a wireless network. The method includes sending, by a base station, a CSI-RS to a UE during an OW and a PW. Further, the method includes receiving, by the base station, a first type CSI report from the UE during the OW, second type CSI report at end of OW and third type report during the PW, only if CSI-RS is received during PW. The first type CSI report includes at least one predictor coefficient. Further, the method includes receiving, by the base station, a second type CSI report from the UE at an end of the OW, where the second type CSI report includes at least one predictor coefficient. Further, if CSI-RS is configured to be received in PW, one third type CSI report is sent for each CSI-RS received in PW.

Accordingly, the embodiments herein provide a UE including a CSI controller coupled with a processor and a memory. The CSI controller is configured to receive a CSI-RS from a base station during an OW, and optionally during PW. Further, the CSI controller is configured to predict a first type CSI report during the OW. Further, the CSI controller is configured to send at least one of the predicted first type CSI report to the base station during the OW and a second type CSI report to the base station at the end of the OW, and a third type CSI report for every CSI-RS that could be present in PW.

Accordingly, the embodiments herein provide a base station including a CSI controller coupled with a processor and a memory. The CSI controller is configured to send a CSI-RS to a UE during an OW and also optionally during PW. Further, the CSI controller is configured to receive a CSI report during the OW and at an end of the OW based on the CSI-RS, and also optionally during PW if the CSI-RS is present in the PW.

Accordingly, the embodiments herein provide a UE including a CSI controller coupled with a processor and a memory. The CSI controller is configured to receive a CSI-RS from a base station (BS) during an observation window (OW) and optionally during a prediction window (PW). Further, the CSI controller is configured to predict a first type CSI report, where the first type CSI report includes at least one predictor coefficient. Further, the CSI controller is configured to send the predicted first type CSI report to the base station during the OW and optionally the third type CSI report during PW if CSI-RS is present in PW. Further, the CSI controller is configured to send a second type CSI report to the base station at the end of the OW, wherein the second type CSI report comprises at least one predictor coefficient.

Accordingly, the embodiments herein provide a base station including a CSI controller coupled with a processor and a memory. The CSI controller is configured to send a CSI-RS to a UE during an observation window (OW) and optionally during a prediction window (PW). Further, the CSI controller is configured to receive a first type CSI report from the UE during the OW The first type CSI report comprises at least one predictor coefficient from the UE at the OW. Further, the CSI controller is configured to receive a second type CSI report from the UE at an end of the OW and a third type CSI report during the PW if the CSI-RS is present in PW, wherein the second type CSI report comprises at least one predictor coefficient.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

FIG. 1A illustrates an example CSI-RS-{OW} scenario (100a) with a different type of CSI reports, according to embodiments as disclosed herein. FIG. 1B illustrates an example CSI-RS-{OW, PW} scenario (100b) with a different type of CSI reports, according to embodiments as disclosed herein.

The basic operation involves an observation window (OW) of N1 samples and a prediction window (PW) of N2 samples. Using any of the methods, some Doppler related feedback is sent by a user equipment (UE) (210) to a base station (BS) (220) at the end of OW, using which the necessary feedback values in PW can be predicted or the feedback in PW can be reduced.

There can be two modes of operation. In a first mode: CSI-RS-{OW} (as illustrated in FIG. 1A). Here Channel State Information Reference Signal (CSI-RS) is sent by the BS (220) to the UE (210) only during OW and CSI reports are only sent for the CSI-RS sent in the OW. The values of W2 or \tilde{W}₂ (these are defined later) matrix are predicted in the PW.

In an embodiment, the UE (210) receives a CSI-RS from the base station (220) during the OW. In an embodiment, a RRC message configures at least one of time instants and periodicities of the CSI-RS that is to be transmitted later by one of an activation low layer trigger and deactivation of low layer trigger via a MAC-CE or a DCI from the base station (220). The UE (210) receives the CSI-RS from the base station (220) upon triggering at least one of a low layer activation message via at least one of the MAC-CE and the DCI by the base station (220). The transmission of the CSI-RS by the base station (220) to the UE (210) is stopped upon triggering at least one of a low layer deactivation message via at least one of the MAC-CE and the DCI from the base station (220).

Further, the UE (210) predicts/computes a first type CSI report (i.e., CSI report type X) during the OW that corresponds to a CSI-RS in a time instant. Further, the UE (210) sends at least one of the predicted first type CSI report to the base station (220) during the OW and a second type CSI report (i.e., CSI report type Y) to the base station (220) at an end of the OW based on the received CSI-RS. The first type CSI report is different from the second type CSI report, and the CSI feedback is managed in a presence of Doppler. The second type CSI report includes at least one predictor coefficient. The second type CSI report is sent after the OW have precoder matrix values for various time instants in the PW in a compressed format. The linear predictor coefficient associated with the second type CSI report is learned using at least one of a machine learning technique and a signal processing technique. The machine learning technique can be, for example, but not limited to a supervised learning technique, an unsupervised learning technique, a semi-supervised learning technique, a reinforcement learning technique or the like. In an embodiment, a predictor order in one of time and frequency for the second type CSI report is determined by using a time domain order and a frequency domain order. The time domain order and the frequency domain order depend on coherence time and coherence bandwidth.

In an embodiment, a set of semi-persistent scheduling covers many OWs. In another embodiment, one semi-persistent scheduling covers the one OW. The transmission is actually switched ON/OFF by the low layer activation/deactivation messages via the MAC-CE/DCI. Together the operations is called as the semi-persistent scheduling. A length of the OW is configured via at least one of the DCI and the MAC-CE during activation. The OW and a PW are defined by the RRC message, where the RRC message includes a CSI-RS burst pattern.

In a second mode, CSI-RS-{OW, PW} (as illustrated in FIG. 1B). Here CSI-RS is sent in both OW and PW and the CSI reports are sent for these CSI-RS in both OW and PW. The values of W2 or \tilde{W}₂ (as defined later) are predicted in PW and CSI reports in PW carry the prediction error which has lesser dynamic range and hence feedback overhead is reduced.

In another embodiment, the UE (210) receives the CSI-RS from the base station (BS) (220) during the OW and the PW. Further, the UE (210) predicts the first type CSI report, where the first type CSI report includes at least one predictor coefficient. Further, the UE (210) sends the predicted first type CSI report including the at least one predictor coefficient to the base station (220) during the OW. Further, the UE (210) sends the second type CSI report to the base station (220) at the end of the OW. The second type CSI report includes at least one predictor coefficient. The third type CSI report is sent by UE 210 to BS 220 for every CSI-RS time instant in the PW. The third type report will carry the prediction error of the prediction matrices for the CSI-RS time instants in PW.

There can be three types of CSI reports (as illustrated in FIGS. 1A and 1B). The three types of CSI reports are explained in FIGS. 2 to 4.

### Scenarios—CSI-RS-{OW}:

FIG. 2 illustrates a possible way to trigger the scenario CSI-RS-{OW} in a wireless network (200), according to embodiments as disclosed herein. The wireless network (200) includes the UE (210) and the base station (220). The UE (210) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The base station (220) can be, for example, but not limited to a eNB, a gNB, and a new radio (NR) base station. A series of semi-persistent scheduling to cover the OW part. The OW duration is the time between low layer activation/deactivation MAC-CE/DCI trigger. Alternatively, the OW length (N1 samples) can be configured vis the DCI or the MAC-CE during activation. Else, the deactivation indicates the end of OW. The CSI-report type Y (i.e., second type CSI report) needs to be sent at end of the OW. The CSI report type X (i.e., first type CSI report) is send for every CSI-RS time instant in the OW. The first type CSI report can be optional and whether to send or not can be configured by the gNB.

As shown in FIG. 2, at 202, the base station (220) sends a higher layer RRC config to the UE (210). In an example, below are the higher layer RRC Config:
a) NZP-CSI-RS-Resource uses PeriodicityandOffset.
b) CSI-Report-config->reportConfigType=Doppler-OW-X (proposed message) X is either PUCCH or PUSCH (depending on MAC-CE or DCI trigger).
c) CSI-Report-config->reportQuantity=method (proposed message) where method is linear channel prediction.

At 204, the base station (220) sends the lower layer trigger activation to the UE (210) through the MAC-CE/DCI. At 206, the base station (220) sends the CSI-RS to the UE (210) at during the OW. At 208, the UE (210) sends the CSI report type X to the base station (220) based on the received CSI-RS 206. At 210, the base station (220) sends the CSI-RS to the UE (210) at a new time instant. At 212, the UE (210) sends the CSI report type X to the base station (220) based on the received CSI-RS. At 214, the base station (220) sends the CSI-RS to the UE (210). At 216, the base station (220) sends the lower layer trigger deactivation to the UE (210) through the MAC-CE/DCI. At 218, the UE (210) sends the CSI report type Y to the base station (220) at the end of the OW based on the all the received CSI-RS received in that OW. The report Y includes precoder matrices that are predicted for one or more time instants in PW and is sent in a compressed format. The compressed format will make use of similarities between the precoder values at various time instants in PW due to channel being correlated.

At 220, the base station (220) sends the lower layer trigger activation to the UE (210) through the MAC-CE/DCI. At 222, the base station (220) sends the CSI-RS to the UE (210). At 224, the UE (210) sends the CSI report type X to the base station (220) based on the received CSI-RS. At 226, the base station (220) sends the CSI-RS to the UE (210) at yet another time instant. At 228, the UE (210) sends the CSI report type X to the base station (220) based on the received CSI-RS. At 230, the base station (220) sends the CSI-RS to the UE (210). At 232, the base station (220) sends the lower layer trigger deactivation to the UE (210) through the MAC-CE/DCI. At 234, the UE (210) sends the CSI report type Y to the base station (220) at the end of the OW based on all the received CSI-RS in that OW. The report Y includes precoder matrices that are predicted for one or more time instants in PW and is sent in a compressed format. The compressed format will make use of similarities between the precoder values at various time instants in PW due to channel being correlated.

### Scenarios—CSI-RS-{OW}:

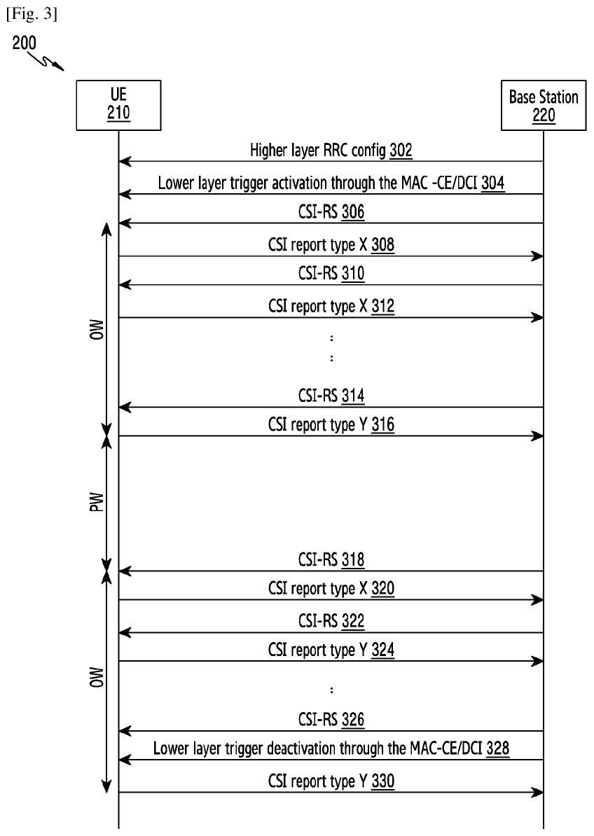

FIG. 3 illustrates another possible way to trigger the scenario CSI-RS-{OW} in the wireless network (200), according to embodiments as disclosed herein. A periodic combination of a few CSI-RS (OW) and silence period (PW) as a new CSI-RS pattern. The OW and PW windows (N1, N2) are defined by the CSI-RS burst pattern (in the RRC message). Activation MAC-CE/DCI can happen in the middle of the OW window. It can specify the length of the OW window (OW-MACCE-DCI-LEN<=N1), where <= is lesser than or equal operator. In every CSI-RS burst at end of the OW (as defined by N1 or OW-MACCE-DCI-LEN<=N1) a CSI-RS type Y report is sent. The MAC-CE/DCI can or cannot have precedence over RRC message. The CSI report type X (i.e., first type CSI report) is send for every CSI-RS time instant in the OW. The first type CSI report can be optional and whether to send or not can be configured by the gNB.

As shown in FIG. 3, at 302, the base station (220) sends the higher layer RRC config to the UE (210). In an example, below are higher layer RRC Config:
a) NZP-CSI-RS-Resource (proposed message) new CSI-RS burst pattern
b) CSI-Report-config->reportConfigType=Doppler-OW-X (proposed message) X is either PUCCH or PUSCH (depending on MAC-CE or DCI trigger).
c) CSI-Report-config->reportQuantity=method (proposed message) where method is one of linear channel prediction.

At 304, the base station (220) sends the lower layer trigger activation to the UE (210) through the MAC-CE/DCI. At 306, the base station (220) sends the CSI-RS to the UE (210) at beginning of the OW. At 308, the UE (210) sends the CSI report type X to the base station (220) based on the received CSI-RS. At 310, the base station (220) sends the CSI-RS to the UE (210) at yet another time instant. At 312, the UE (210) sends the CSI report type X to the base station (220) based on the received CSI-RS. At 314, the base station (220) sends the CSI-RS to the UE (210). At 316, the UE (210) sends the CSI report type Y to the base station (220) at the end of the OW based on all the received CSI-RS in that OW. The report Y includes precoder matrices that are predicted for one or more time instants in PW and is sent in a compressed format. The compressed format will make use of similarities between the precoder values at various time instants in PW due to channel being correlated.

At 318, the base station (220) sends the CSI-RS to the UE (210). At 320, the UE (210) sends the CSI report type X to the base station (220) based on the received CSI-RS. At 322, the base station (220) sends the CSI-RS to the UE (210). At 324, the UE (210) sends the CSI report type X to the base station (220) based on the received CSI-RS. At 326, the base station (220) sends the CSI-RS to the UE (210). At 328, the base station (220) sends the lower layer trigger deactivation to the UE (210) through the MAC-CE/DCI. At 330, the UE (210) sends the CSI report type Y to the base station (220) at the end of the OW based on all the received CSI-RS in that OW. The report Y includes precoder matrices that are predicted for one or more time instants in PW and is sent in a compressed format. The compressed format will make use of similarities between the precoder values at various time instants in PW due to channel being correlated.

### Scenario—CSI-RS-{OW, PW}:

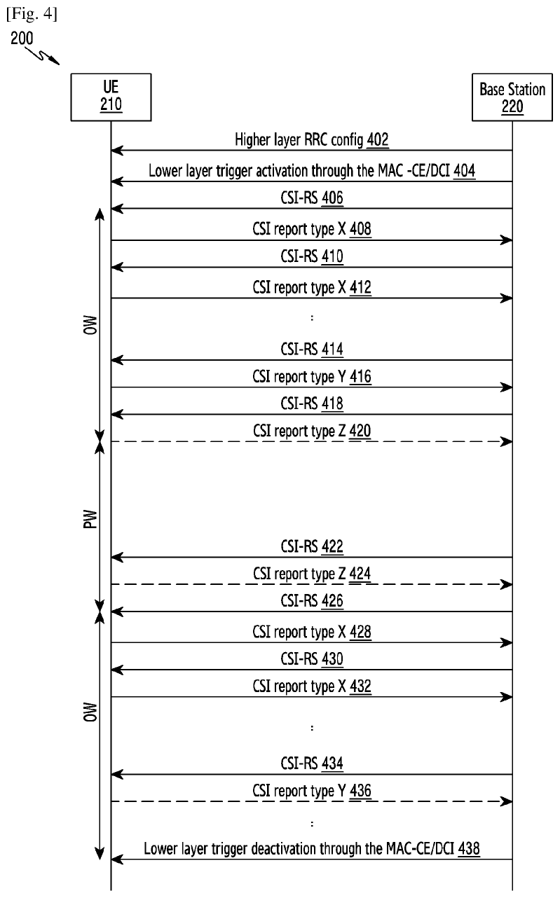

FIG. 4 illustrates a possible way to trigger the scenario CSI-RS-{OW, PW} in the wireless network (200), according to embodiments as disclosed herein. A semi-persistent configuration can be used. The DCI activation/MAC-CE tells the length of OW (N1), PW (N2), where N1, N2 can be configured by RRC signalling as well (see later slides). The DCI/MAC-CE can or cannot override the RRC signalling.

As shown in FIG. 4, at 402, the base station (220) sends the higher layer RRC config to the UE (210). In an example, below are higher layer RRC Config:
a) NZP-CSI-RS-Resource->periodicityAndOffset
b) CSI-Report-config->reportConfigType=Doppler-OW-PW-X (proposed message) X is either PUCCH or PUSCH (depending on MAC-CE or DCI trigger).
c) CSI-Report-config->reportQuantity=method (proposed message) where method is one of linear channel prediction or LCP.

At 404, the base station (220) sends the lower layer trigger activation to the UE (210) through the MAC-CE/DCI. At 406, the base station (220) sends the CSI-RS to the UE (210) at beginning of the OW. At 408, the UE (210) sends the CSI report type X to the base station (220) based on the received CSI-RS. At 410, the base station (220) sends the CSI-RS to the UE (210). At 412, the UE (210) sends the CSI report type X to the base station (220) based on the received CSI-RS. At 414, the base station (220) sends the CSI-RS to the UE (210). At 416, the UE (210) sends the CSI report type Y to the base station (220) based on all the received CSI-RS in OW. At 418, the base station (220) sends the CSI-RS to the UE (210) in the PW. At 420, the UE (210) sends the CSI report type Z (e.g., third type CSI report) to the base station (220) based on the received CSI-RS in PW. At 422, the base station (220) sends the CSI-RS to the UE (210) in the PW. At 424, the UE (210) sends the CSI report type Z (e.g., third type CSI report) to the base station (220) based on the received CSI-RS in the PW.

At 426, the base station (220) sends the CSI-RS to the UE (210). At 428, the UE (210) sends the CSI report type X to the base station (220) based on the received CSI-RS. At 430, the base station (220) sends the CSI-RS to the UE (210). At 432, the UE (210) sends the CSI report type X to the base station (220) based on the received CSI-RS. At 434, the base station (220) sends the CSI-RS to the UE (210). At 436, the UE (210) sends the CSI report type Y to the base station (220) at the OW based on the received CSI-RS. At 438, the base station (220) sends the lower layer trigger deactivation to the UE (210) through the MAC-CE/DCI. The CSI report type X (i.e., first type CSI report) is send for every CSI-RS time instant in the OW. The first type CSI report can be optional and whether to send or not can be configured by the gNB. The CSI report type Z (i.e., third type CSI report) is send for every CSI-RS time instant in the PW. The first and third type CSI report can be optional and whether to send or not can be configured by the gNB. The report Y includes precoder matrices that are predicted for one or more time instants in PW and is sent in a compressed format. The compressed format will make use of similarities between the precoder values at various time instants in PW due to channel being correlated.

### Linear Prediction:

W₁, W₂, \tilde{W}₂, W_{f} be the codebook matrices extended across multiple time instants (third dimension). W₁ be 2N_{T}×2L (2 no. of Tx antennas×2 no. of beams). W₂ be 2L×N₃×N (2 no. of beams×no. of subbands×no. of time instants). \tilde{W}₂ be 2L×M×N (2 no. of beams×no. of FD compressed elements (delay)×no. of time instants). W_{f} is N₃×M matrix. We have at any time instant n,

W(:,:,n)=W₁(:,:,n)W₂(:,:,n)=W₁(:,:,n)\tilde{W}₂(:,:,n)W_{f}^{H}

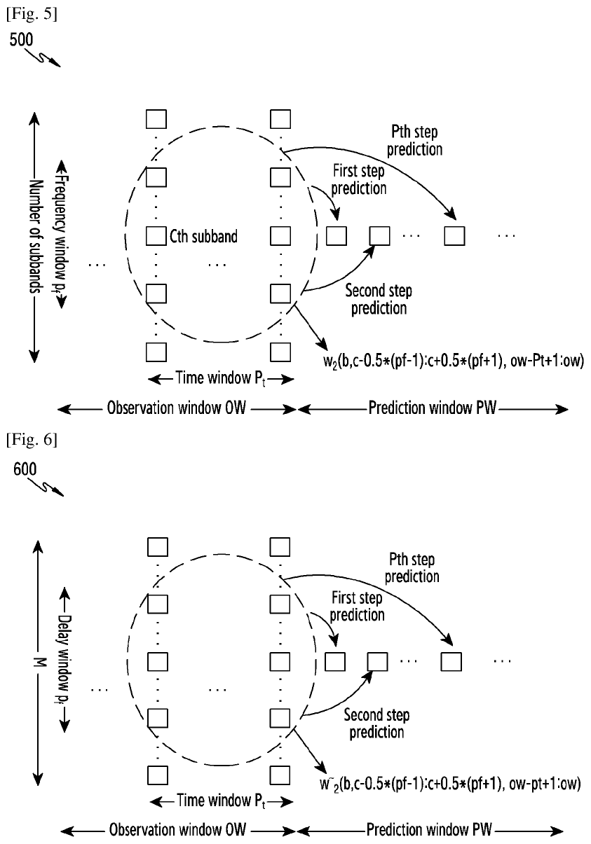

) FIG. 5 illustrates a 2D-prediction (500) of the cth subband corresponding to the bth beam for elements of W2, according to embodiments as disclosed herein.

Linear prediction of elements of W2:

Time domain order denoted by Pt and frequency domain order by Pf. Pt and Pf will depend on coherence time and coherence bandwidth. The linear prediction can be p steps into future. The linear prediction coefficients are denoted by L(Pₜ,P_{f},c,p,l,pol,b) where l is the layer, p is for the pth step prediction and pol is the polarization. Linear predictor coefficients can be learnt by the machine learning like Recurrent Neural Network (RNN) or signal processing techniques.

FIG. 6 illustrates a 2D-prediction (600) of the cth FD component (delay) corresponding to the bth beam for elements of \tilde{W}₂, according to embodiments as disclosed herein.

### Linear Prediction of Elements of \tilde{W}₂:

Time domain order denoted by Pt and FD component (delay) domain order by Pf. Pt and Pf will depend on coherence time and coherence bandwidth. The linear prediction can be p steps into future. The linear prediction coefficients are denoted by L(Pₜ,P_{f},c,p,l,pol,b) where l is the layer, p is for the pth step prediction and pol is the polarization. The linear predictor coefficients can be learnt by machine learning like RNN or signal processing techniques.

At each time instant, both the BS (220) and the UE (210) save a state variable which is an element of W₂ or \tilde{W}₂. In the PW, this state is the predicted state value plus a quantized version of a prediction error from the UE (210) which is sent in third type or CSI Type Z report. In the OW, this state is just the quantized value from the UE (210) which is sent by the first type or the CSI report type X. The state value for a future time instant is predicted, using predictor coefficients, using the past state values. The prediction using prediction coefficients and state values are same at both BS (220) and UE (210). The predictor coefficients are sent by the UE (210) to the BS (220) at end of the OW in the CSI-report Y or second type of CSI report or the BS (220) sends them to the UE (210) via the DCI or the MAC-CE well before start of PW.

Table 1 describes the new message information.

TABLE 1

| S. NO | New Message | Description |
|---|---|---|
| 1. | CSI Report Type X | Current report format |
| 2. | CSI Report Type Y | Sent at end of OW. Apart from existing rel-16 payload, |
| | | Typically consists of LCP coefficients to be used for |
| | | prediction in the PW. Additionally, it can send Doppler |
| | | related information. |
| 3. | CSI Report Type Z | CSI report in PW. Very similar to CSI report type X but |
| | | instead of carrying values of w₂ or \tilde{W}₂, it carries prediction |
| | | error of elements of w₂ or \tilde{W}₂, which is less in magnitude |
| | | and hence feedback reduced. Additionally, it can send |
| | | Doppler related information. |
| 4. | CSI-Report-config −> | Used for CSI-RS-{OW}. CSI-RS only in OW. Configures |
| | reportConfigType = | first (N1-1) reports as CSI report Type X and N1th report as |
| | Doppler-OW-PUCCH | CSI report type Y. reporting on PUCCH. Trigger MAC-CE. |
| | | This is in addition to existing semipersistentOnPUCCH field |
| | | in the standards. |
| 5. | CSI-Report-config −> | Used for CSI-RS-{OW}. CSI-RS only in OW. Configures |
| | reportConfigType = | first (N1-1) reports as CSI report Type X and N1th report as |
| | Doppler-OW-PUSCH | CSI report type Y. reporting on PUSCH. Trigger DCI. This |
| | | is in addition to existing semipersistentOnPUSCH field in |
| | | the standards. |
| 6. | CSI-Report-config −> | Method used is LCP. Has configurations. New type |
| | reportQuantity | extensions of CRI-RI-PMI-CQI-LCP an extension of |
| | | CRI-RI-PMI-CQI and CRI-RI-LI-PMI-CQI-LCP an |
| | | extension of CRI-RI-PMI-CQI. |
| 7. | NZP-CSI-RS-Resource −> | Defines a new pattern of CSI-RS (periodic in OW + PW, but |
| | CSIRS-Pattern | present only in OW). |
| 8. | CSI-Report-config −> | Used for CSI-RS-{OW, PW}. CSI-RS in OW, PW. |
| | reportConfigType = | Configures first (N1-1) reports as CSI report Type X and |
| | Doppler-OW-PW- | N1th report as CSI report type Y, next N2 reports as CSI- |
| | PUCCH | report type Z. reporting on PUCCH. Trigger MAC-CE. This |
| | | is in addition to existing semipersistentOnPUCCH field in |
| | | existing standards. |
| 9. | CSI-Report-config −> | Used for CSI-RS-{OW, PW}. CSI-RS in OW, PW. |
| | reportConfigType = | Configures first (N1-1) reports as CSI report Type X and |
| | Doppler-OW-PW- | N1th report as CSI report type Y, next N2 reports as CSI- |
| | PUSCH | report type Z. reporting on PUSCH. Trigger DCI. This is in |
| | | addition to existing semipersistentOnPUSCH field in the |
| | | standards. |

### NZP-CSI-RS-Resource:

The CSI-burst information has three parameters N1, N2, and N2 Flag. Length of the OW (N1) and the PW windows (N2) based on CSI-RS occasions. The N2 Flag will say if the CSI-RS is present in the PW or not, N1 number of CSI-RS in the OW and N2 is number of CSI-RS in PW. If N2 Flag=0 which means no CSI-RS in the PW, then what the user of the UE (210) get is a CSI-RS burst. That is N1 CSI-RS occasions followed by no CSI-RS in next N2 occasions (based on slot periodicity and offset, an existing parameter). The CSI-R occasions determined by slot periodicity and offset (existing). Let it be P, off, respectively. For P=2 and off=0, the CSI-RS pattern is 1, 0, 1, 0, 1, 0, 1, 0, 1, 0, 1, 0, 1 where 0 means CSI-RS is absent in a slot and 1 means present.

### CSI-Report-config->reportQuantity:

New type extensions of CRI-RI-PMI-CQI-LCP, an extension of CRI-RI-PMI-CQI and CRI-RI-LI-PMI-CQI-LCP, an extension of CRI-RI-LI-PMI-CQI are disclosed herein. During the OW, it will be same as existing payload Rel-16 (CRI-RI-PMI-CQI or CRI-RI-LI-PMI-CQI), (elements of W₂ or \tilde{W}₂). Additionally, it can send Doppler related information. This is Type X. At end of OW, it will be same as existing payload Rel-16 (CRI-RI-PMI-CQI or CRI-RI-LI-PMI-CQI), (elements of W₂ or \tilde{W}₂). Additionally, it will mainly have LCP coefficients reported (various embodiments) reported at end of the OW. Additionally, it can send Doppler related information. This is Type Y. During PW, it will report quantized prediction error values of W₂ or \tilde{W}₂ (instead of W₂ or \tilde{W}₂ for CRI-RI-PMI-CQI or CRI-RI-LI-PMI-CQI). Additionally, it can send Doppler related information. This is Type Z.

Another embodiment for CSI-Report-config->reportQuantity is as follows. As we know, the BS (220) and the UE (210) stores state variables which is an estimate of element of W₂ or \tilde{W}₂.

There can be a fixed number of methods known apriori that calculates LCP coefficients based on these state variables in the OW window. Rather than explicitly feeding back the LCP coefficients, the UE (210) can just send the index of the method used to arrive at the LCP coefficients. Or the BS (220) can send index of the method used to arrive at LCP coefficients to the UE (210) via the DCI or the MAC-CE. This is to save feedback. Note that the BS (220) and the UE (210) will have same copy of LCP coefficients and do similar prediction.

### Various Embodiments for Predictor Coefficients of W2:

Linear prediction coefficients are denoted by L (Pₜ,P_{f},c,p,l,pol,b) where l is the layer, p is for the pth step prediction and pol is the polarization. For each of c, l, pol, b, a set of K step predictors can be there and their corresponding values of Pₜ, P_{f} and also Pₜ*P_{f} predictor coefficients, i.e., four arrays of size K, one for set of step predictions, second and third for corresponding Pₜ, P_{f} values and fourth for corresponding coefficients. This is denoted by [p_arr, Pt_arr, Pf_arr, coeff_arr]=func(c,l,pol,b).

func has four variables c, l, pol, b. It's output can be constant over A=1, 2, 3 or 4 variables and differ in the remaining 4-A variables. A variables can be selected in 4CA ways.

For example A=2,
a. It can be constant across layers and polarizations but vary across beams and subbands.
b. It can be constant over subbands and beams but vary across layers and polarization.

### Various Embodiments for Predictor Coefficients of \tilde{W}₂:

Here N3 subbands get compressed to M values (referred to as delay values). So L(.) and func are exactly as before, but reference to subband is replaced by a reference to delay value (c). func has four variables c, l, pol, b. It's output can be constant over A=1, 2, 3 or 4 variables and differ in the remaining 4-A variables. A variables can be selected in 4CA ways.

For example A=2,
a. It can be constant across layers and polarizations but vary across beams and subbands.
b. It can be constant over subbands and beams but vary across layers and polarization.

### Edge Effect:

In a given band, if c is such that it is less than P_{f} away from edge then some of coefficients corresponding to the unavailable subbands are zero.

In this patent feedback messaging is discussed in the context of linear channel prediction. It can be extended to accommodate the other methods like Doppler coefficients based on spectral estimation, Kalman etc by suitably modifying the CSI-Report-config->reportQuantity and other aspects of this patent.

Slepian sequences or discrete prolate spheroidal sequences can replace the Doppler coefficient based method for reconstruction of elements of elements of W₂ or \tilde{W}₂ and can be used feedback too. The elements of W₂ or \tilde{W}₂ can be approximated by linear, parabolic or cubic/spline curves in the OW and this curve can be used to predict in PW. Curve related parameters could be feedback as an extension of this method as well.

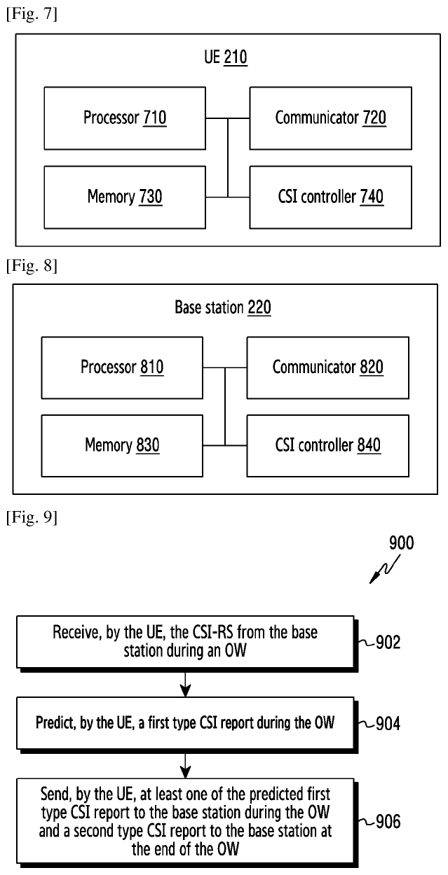

FIG. 7 illustrates various hardware components of the UE (210), according to the embodiments as disclosed herein. In an embodiment, the UE (210) includes a processor (710), a communicator (720), a memory (730) and a CSI controller (740). The processor (710) is coupled with the communicator (720), the memory (730) and the CSI controller (740).

In an embodiment, the CSI controller (740) receives the CSI-RS from the base station (220) during the OW. In an embodiment, the CSI controller (740) receives the CSI-RS from the base station (220) upon triggering at least one of the low layer activation message via at least one of the MAC-CE and the DCI by the base station (220). The transmission of the CSI-RS by the base station (220) to the UE (210) is stopped upon triggering at least one of the low layer deactivation message via at least one of the MAC-CE and the DCI from the base station (220). Further, the CSI controller (740) predicts the first type CSI report during the OW. Further, the CSI controller (740) sends at least one of the predicted first type CSI report to the base station (220) during the OW and the second type CSI report to the base station (220) at the end of the OW based on the received CSI-RS, third type CSI report during PW. In an embodiment, the second type CSI report includes at least one predictor coefficient. The first type CSI report is different from the second type CSI report, and the CSI feedback is managed in the presence of Doppler. The second type CSI report is sent after the OW have precoder matrix values for various time instants in the PW in a compressed format.

In another embodiment, the CSI controller (740) receives the CSI-RS from the base station (BS) (220) during the OW and the PW. Further, the CSI controller (740) predicts the first type CSI report. The first type CSI report includes at least one predictor coefficient. Further, the CSI controller (740) sends the predicted first type CSI report including the at least one predictor coefficient to the base station (220) during the OW. Further, the CSI controller (740) sends the second type CSI report to the base station (220) at the end of the OW and a third type CSI report during the PW if CSI-RS is present in PW. The second type CSI report includes at least one predictor coefficient.

The CSI controller (740) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (710) is configured to execute instructions stored in the memory (730) and to perform various processes. The communicator (720) is configured for communicating internally between internal hardware components and with external devices via one or more networks. The memory (730) also stores instructions to be executed by the processor (710). The memory (730) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (730) may, in some examples, be considered a non-transitory storage medium. The term “non-transitory” may indicate that the storage medium is not embodied in a carrier wave or a propagated signal. However, the term “non-transitory” should not be interpreted that the memory (730) is non-movable. In certain examples, a non-transitory storage medium may store data that can, over time, change (e.g., in Random Access Memory (RAM) or cache).

Although the FIG. 7 illustrates various hardware components of the UE (210) but it is to be understood that other embodiments are not limited thereon. In other embodiments, the UE (210) may include less or more number of components. Further, the labels or names of the components are used only for illustrative purpose and does not limit the scope of the invention. One or more components can be combined together to perform same or substantially similar function in the UE (210).

FIG. 8 illustrates various hardware components of the base station (220), according to the embodiments as disclosed herein. In an embodiment, the base station (220) includes a processor (810), a communicator (820), a memory (830) and a CSI controller (840). The processor (810) is coupled with the communicator (820), the memory (830) and the CSI controller (840).

In an embodiment, the CSI controller (840) sends the CSI-RS to the UE (210) during the OW and optionally during PW. Based on the CSI-RS, the CSI controller (840) receives the CSI report from the UE (210) at the end of the OW. Further, the CSI controller (840) receives another CSI report from the UE (210) during the OW and another one during the PW. Another CSI report is the first type CSI report and another CSI report is the second type CSI report and third type CSI report. The first type CSI report includes at least one predictor coefficient, and the second type CSI report includes at least one predictor coefficient.

In an embodiment, the CSI controller (840) sends the CSI-RS to the UE (210) during the OW and the PW. Further, the CSI controller (840) receives the first type CSI report from the UE (210) during the OW). The first type CSI report includes at least one predictor coefficient from the UE (210) at the OW. The at least one predictor coefficient is predicted during the OW. Further, the CSI controller (840) receives the second type CSI report from the UE (210) at an end of the OW, where the second type CSI report includes at least one predictor coefficient. The third type CSI report is received during PW.

The CSI controller (840) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (810) is configured to execute instructions stored in the memory (830) and to perform various processes. The communicator (820) is configured for communicating internally between internal hardware components and with external devices via one or more networks. The memory (830) also stores instructions to be executed by the processor (810). The memory (830) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (830) may, in some examples, be considered a non-transitory storage medium. The term “non-transitory” may indicate that the storage medium is not embodied in a carrier wave or a propagated signal. However, the term “non-transitory” should not be interpreted that the memory (830) is non-movable. In certain examples, a non-transitory storage medium may store data that can, over time, change (e.g., in Random Access Memory (RAM) or cache).

Although the FIG. 8 illustrates various hardware components of the base station (220) but it is to be understood that other embodiments are not limited thereon. In other embodiments, the base station (220) may include less or more number of components. Further, the labels or names of the components are used only for illustrative purpose and does not limit the scope of the invention. One or more components can be combined together to perform same or substantially similar function in the base station (220).

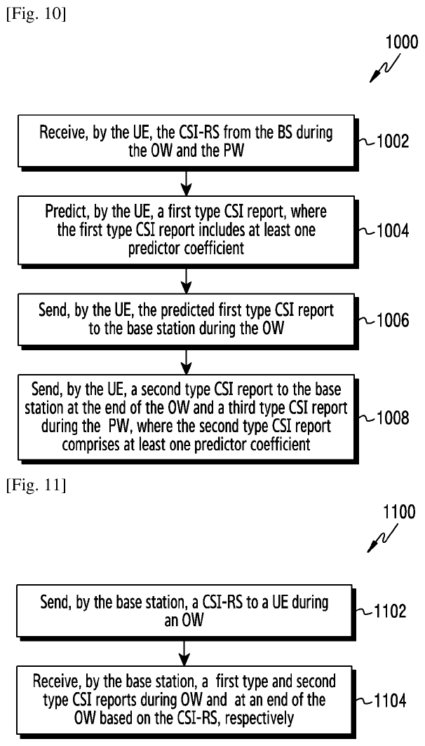

FIGS. 9 and 10 illustrate flow charts (900 and 1000) illustrating a method, implemented by the UE (210), for managing the CSI in the wireless network (200), according to the embodiments as disclosed herein.

As shown in FIG. 9, the operations (902-906) are handled by the CSI controller (740). At 902, the method includes receiving the CSI-RS from the base station (220) during the observation window (OW). At 904, the method includes predicting the first type CSI report during the OW. At 906, the method includes sending at least one of the predicted first type CSI report to the base station (220) during the OW and the second type CSI report to the base station (220) at the end of the OW based on the received CSI-RS.

As shown in FIG. 10, the operations (1002-1008) are handled by the CSI controller (740). At 1002, the method includes receiving the CSI-RS from the BS (220) during the OW and the PW. At 1004, the method includes predicting the first type CSI report. The first type CSI report includes at least one predictor coefficient and. At 1006, the method includes sending the predicted first type CSI report comprising the at least one predictor coefficient to the base station (220) during the OW. At 1008, the method includes sending the second type CSI report to the base station (220) at the end of the OW and a third type CSI report during the PW. The second type CSI report includes at least one predictor coefficient.

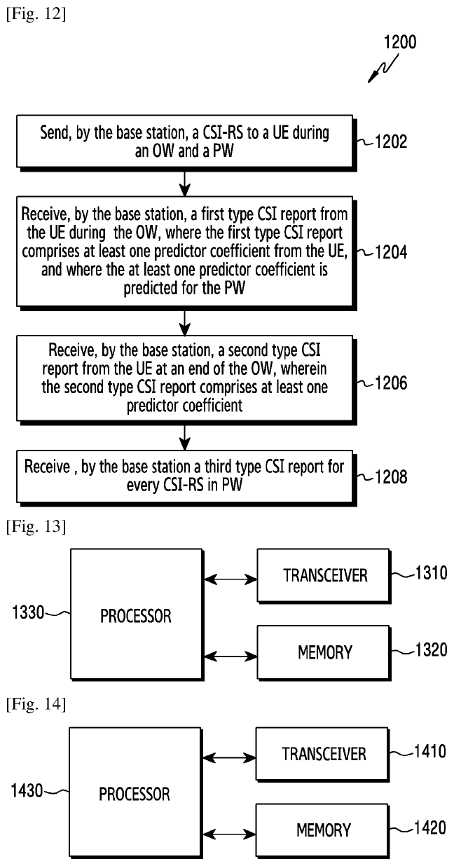

FIGS. 11 and 12 illustrate flow charts (1100 and 1200) illustrating a method, implemented by the base station (220), for managing the CSI in the wireless network (200), according to the embodiments as disclosed herein.

As shown in FIG. 11, the operations (1102-1104) are handled by the CSI controller (840). At 1102, the method includes sending the CSI-RS to the UE (210) during the OW. At 1104, the method includes receiving by the base station, a first type and second type CSI reports during OW and at an end of the OW based on the CSI-RS, respectively.

As shown in FIG. 12, the operations (1202-1206) are handled by the CSI controller (840). At 1202, the method includes sending the CSI-RS to the UE (210) during the OW and the PW. At 1204, the method includes receiving the first type CSI report from the UE (210) during the OW, where the first type CSI report comprises at least one predictor coefficient from the UE (210), and where the at least one predictor coefficient is predicted for the PW. At 1206, the method includes receiving the second type CSI report from the UE (210) at an end of the OW, wherein the second type CSI report comprises at least one predictor coefficient. At 1208, the method includes receiving the third type CSI report for every CSI-RS in the PW.

FIG. 13 illustrates a block diagram illustrating a structure of a user equipment (UE) according to an embodiment of the disclosure. FIG. 13 corresponds to the example of the UE of FIG. 7.

As shown in FIG. 13, the UE according to an embodiment may include a transceiver 1310, a memory 1320, and a processor 1330. The transceiver 1310, the memory 1320, and the processor 1330 of the UE may operate according to a communication method of the UE described above. However, the components of the UE are not limited thereto. For example, the UE may include more or fewer components than those described above. In addition, the processor 1330, the transceiver 1310, and the memory 1320 may be implemented as a single chip. Also, the processor 1330 may include at least one processor.

The transceiver 1310 collectively refers to a UE receiver and a UE transmitter, and may transmit/receive a signal to/from a base station or a network entity. The signal transmitted or received to or from the base station or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the UE. Also, the memory 1320 may store control information or data included in a signal obtained by the UE. The memory 1320 may be a storage medium, such as read-only memory (ROM), random access memory (RAM), a hard disk, a CD-ROM, and a DVD, or a combination of storage media.

The processor 1330 may control a series of processes such that the UE operates as described above. For example, the transceiver 1310 may receive a data signal including a control signal transmitted by the base station or the network entity, and the processor 1330 may determine a result of receiving the control signal and the data signal transmitted by the base station or the network entity.

FIG. 14 illustrates a block diagram illustrating a structure of a base station (BS) according to an embodiment of the disclosure. FIG. 14 corresponds to the example of the base station of FIG. 8.

As shown in FIG. 14, the base station according to an embodiment may include a transceiver 1410, a memory 1420, and a processor 1430. The transceiver 1410, the memory 1420, and the processor 1430 of the base station may operate according to a communication method of the base station described above. However, the components of the base station are not limited thereto. For example, the base station may include more or fewer components than those described above. In addition, the processor 1430, the transceiver 1410, and the memory 1420 may be implemented as a single chip. Also, the processor 1430 may include at least one processor.

The transceiver 1410 collectively refers to a base station receiver and a base station transmitter, and may transmit/receive a signal to/from a terminal or a base station. The signal transmitted or received to or from the terminal or a base station may include control information and data. The transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the base station. Also, the memory 1420 may store control information or data included in a signal obtained by the base station. The memory 1420 may be a storage medium, such as read-only memory (ROM), random access memory (RAM), a hard disk, a CD-ROM, and a DVD, or a combination of storage media.

The processor 1430 may control a series of processes such that the base station operates as described above. For example, the transceiver 1410 may receive a data signal including a control signal transmitted by the terminal, and the processor 1430 may determine a result of receiving the control signal and the data signal transmitted by the terminal.

According to various embodiments, a method performed by a user equipment (UE) in a wireless communication system, comprising: receiving, from a base station, a channel state information (CSI)-reference signal (RS) during an observation window (OW); predicting at least one first type CSI report during the OW; transmitting, to the base station, the at least one predicted first type CSI report during the OW and a second type CSI report at an end of the OW based on the received CSI-RS.

In one embodiment, wherein the second type CSI report comprises at least one predictor coefficient, wherein a set of semi-persistent scheduling covers a plurality of OWs, and wherein one semi-persistent scheduling covers the one OW.

In one embodiment, wherein a radio resource control (RRC) message configures at least one of time instants of periodicities of the CSI-RS, and wherein the CSI-RS is transmitted later by activation low layer trigger via a MAC (medium access control)-CE (control element) or a DCI (downlink control information) from the base station.

In one embodiment, wherein the method further comprises: receiving, from the base station, the CSI-RS upon triggering at least one low layer activation message via at least one of a MAC-CE or a DCI, wherein a low layer activation occurs in a middle of the OW.

In one embodiment, wherein the transmission of the CSI-RS is stopped upon triggering at least one a low layer deactivation message via at least one of a MAC-CE or a DCI.

In one embodiment, wherein a length of the OW is configured via at least one of a DCI or a MAC-CE during activation, and wherein the OW and a prediction window (PW) are defined by an RRC message comprising a CSI-RS burst pattern.

In one embodiment, wherein at least one linear predictor coefficient associated with the second type CSI report is learned using at least one of a machine learning technique or a signal processing technique, wherein a predictor order in one of time and frequency for the second type CSI report is determined by using a time domain order and a frequency domain order, and wherein the time domain order and the frequency domain order depend on coherence time and coherence bandwidth.

In one embodiment, wherein the at least one first type CSI report is different from the second type CSI report, and wherein the first type CSI report and the second type CSI report are managed in a presence of doppler.

In one embodiment, wherein the second type CSI report is transmitted after the OW and includes precoder matrix values for various time instants in a PW in a compressed format.

According to various embodiments, a method performed by a base station in a wireless communication system, comprising: transmitting, to a user equipment (UE), a channel state information (CSI)-reference signal (RS) during an observation window (OW); receiving, from the UE, at least one predicted first type CSI report based on the CSI-RS, wherein the at least one predicted first type CSI report is predicted by the UE during the OW; and receiving, from the UE, a second type CSI report at an end of the OW based on the CSI-RS.

In one embodiment, wherein the second type CSI report comprises at least one predictor coefficient, wherein a set of semi-persistent scheduling covers a plurality of OWs, and wherein one semi-persistent scheduling covers the one OW.

In one embodiment, wherein the method further comprises: transmitting, to the UE, the CSI-RS upon triggering at least one low layer activation message via at least one of a MAC-CE or a DCI, wherein a low layer activation occurs in a middle of the OW.

In one embodiment, wherein a length of the OW is configured via at least one of a DCI or a MAC-CE during activation, and wherein the OW and a prediction window (PW) are defined by an RRC message comprising a CSI-RS burst pattern.

According to various embodiments, a user equipment (UE) in a wireless communication system, comprising: at least one transceiver; and controller coupled with the at least one transceiver, and configured to: receive, from a base station, a channel state information (CSI)-reference signal (RS) during an observation window (OW), predict at least one first type CSI report during the OW, transmit, to the base station, the at least one predicted first type CSI report during the OW and a second type CSI report at an end of the OW based on the received CSI-RS.

According to various embodiments, a base station in a wireless communication system, comprising: at least one transceiver; and controller coupled with the at least one transceiver, and configured to: transmit, to a user equipment (UE), a channel state information (CSI)-reference signal (RS) during an observation window (OW), receive, from the UE, at least one predicted first type CSI report based on the CSI-RS, wherein the at least one predicted first type CSI report is predicted by the UE during the OW, and receive, from the UE, a second type CSI report at an end of the OW based on the CSI-RS.

The various actions, acts, blocks, steps, or the like in the flow charts (900-1200) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1-15. (canceled)

16. A user equipment (UE) in a wireless communication system, the UE comprising:
a transceiver; and
a controller coupled to the transceiver, and configured to:
receive, from a base station, information configuring a first window and a second window,
receive, from the base station, a channel state information (CSI)-reference signal (RS) in the first window,
generate a first CSI report by measuring the CSI-RS during the first window,
transmit, to the base station, the first CSI report during the second window,
generate a second CSI report based on a prediction during the second window, and
transmit, to the base station, the second CSI report.

17. The UE of claim 16, wherein the information is received via higher layer signaling.

18. The UE of claim 16, wherein the CSI-RS is a semi-persistent CSI-RS.

19. The UE of claim 16, wherein the CSI-RS is received upon reception of a triggering instance.

20. A base station in a wireless communication system, the base station comprising:
a transceiver; and
a controller coupled to the transceiver, and configured to:
transmit, to a user equipment (UE), information configuring a first window and a second window,
transmit, to the UE, a channel state information (CSI)-reference signal (RS) in the first window,
receive, from the UE, a first CSI report during the second window, and
receive, from the UE, a second CSI report,
wherein the first CSI report is generated based on a measurement of the CSI-RS during the first window, and
wherein the second CSI report is generated based on a prediction during the second window.

21. The base station of claim 20, wherein the information is transmitted via higher layer signaling.

22. The base station of claim 20, wherein the CSI-RS is a semi-persistent CSI-RS.

23. The base station of claim 20, wherein the CSI-RS is transmitted upon transmission of a triggering instance.

24. A method performed by a user equipment (UE) in a wireless communication system, the method comprising:
receiving, from a base station, information configuring a first window and a second window;
receiving, from the base station, a channel state information (CSI)-reference signal (RS) in the first window;
generating a first CSI report by measuring the CSI-RS during the first window;
transmitting, to the base station, the first CSI report during the second window;
generating a second CSI report based on a prediction during the second window; and
transmitting, to the base station, the second CSI report.

25. The method of claim 24, wherein the information is received via higher layer signaling.

26. The method of claim 24, wherein the CSI-RS is a semi-persistent CSI-RS.

27. The method of claim 24, wherein the CSI-RS is received upon reception of a triggering instance.

28. A method performed by a base station in a wireless communication system, the method comprising:
transmitting, to a user equipment (UE), information configuring a first window and a second window;
transmitting, to the UE, a channel state information (CSI)-reference signal (RS) in the first window;
receiving, from the UE, a first CSI report during the second window; and
receiving, from the UE, a second CSI report,
wherein the first CSI report is generated based on a measurement of the CSI-RS during the first window, and
wherein the second CSI report is generated based on a prediction during the second window.

29. The method of claim 13, wherein the information is transmitted via higher layer signaling.

30. The method of claim 13, wherein the CSI-RS is a semi-persistent CSI-RS.

31. The method of claim 13, wherein the CSI-RS is transmitted upon transmission of a triggering instance.
